(19) United States
(12) Patent Application Publication
(10) Pub. No.: US 2010/0016072 A1
(43) Pub. Date: Jan. 21, 2010

(54) Group users authentication and authorization using time reversal transformation

(76) Inventors: Tong Lai Yu, Yorba Linda, CA (US); Yvonne Yu, Hong Kong (CN)

Correspondence Address: TONG LA YU, 20440 LONGBAY DRIVE, YORBA LINDA, CA, 92887, US

(21) Appl. No.: 12/219,254

(22) Filed: Jul. 18, 2008

(51) Int. Cl. H04L 9/32

(52) U.S. Cl. 463/29

(57) ABSTRACT

Alphabets consisting of letters (‘A’-‘Z’) minus ‘O’ and digits (‘0’-‘9’) are used to form a sequential code where all the codewords are unique. A sequential codeword is used to generate another unique pseudo-random codeword with larger code length using the Time Reversal Transformation (TRT). A TRT codeword is divided into a number of equal-sized sub-codewords which are used to authenticate a group of users to play Internet-based hand-held video games. A sub-codeword has the format that every two alphabets are followed by a digit to avoid the possibility of the occurrence of any obscene words.

### CROSS-REFERENCE TO RELATED APPLICATIONS

There is no other patent application that directly relates to this application.

### FEDERALLY SPONSORED RESEARCH

Not Applicable.

### SEQUENCE LISTING OR PROGRAM

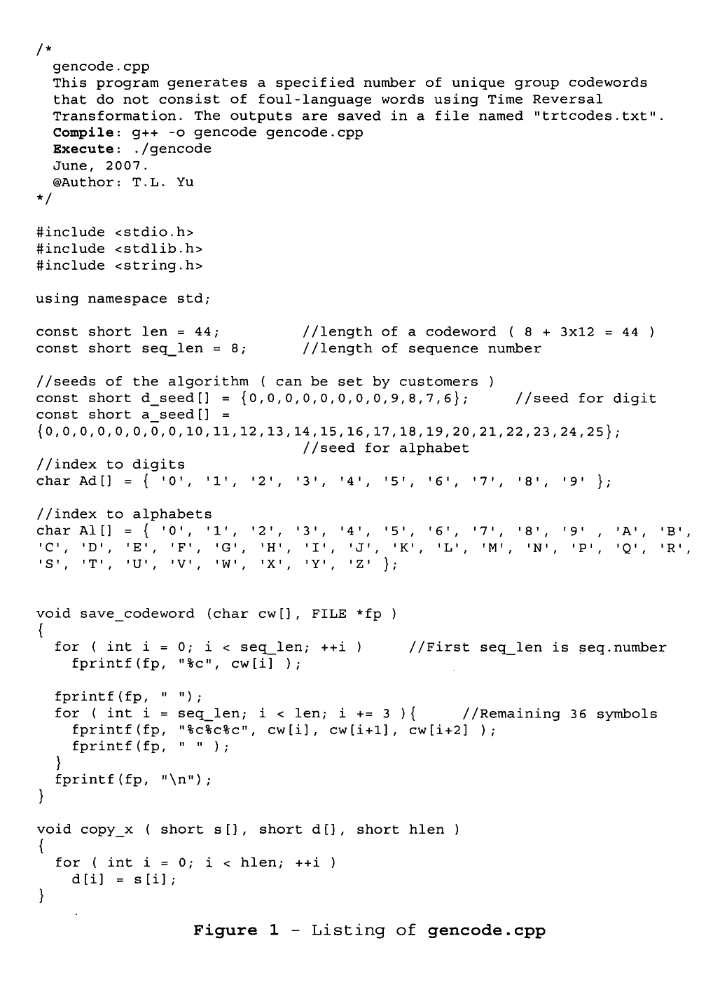

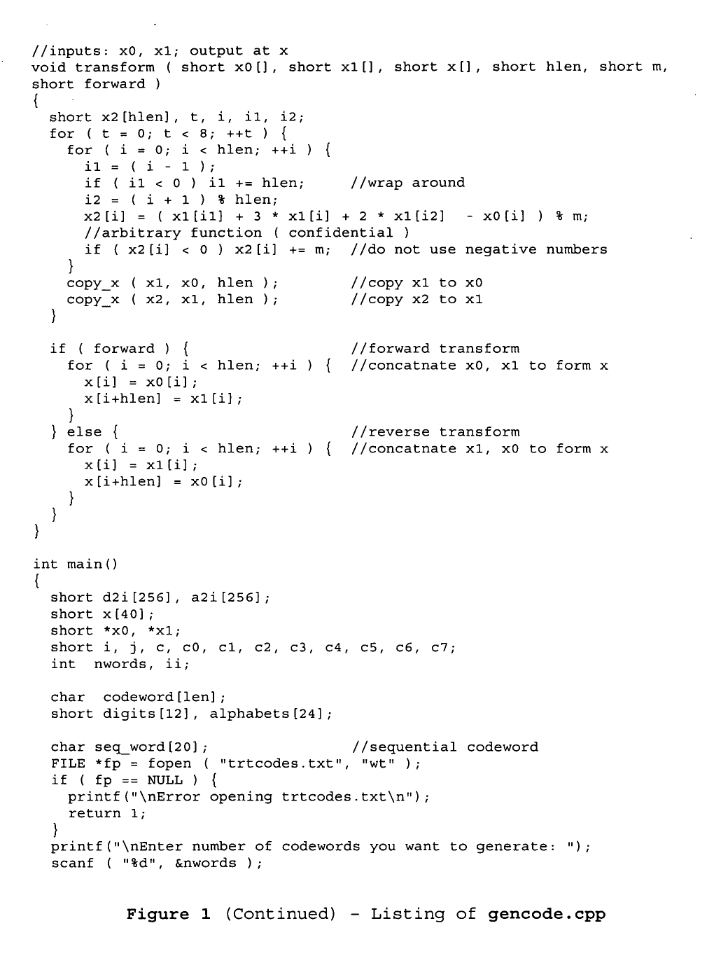

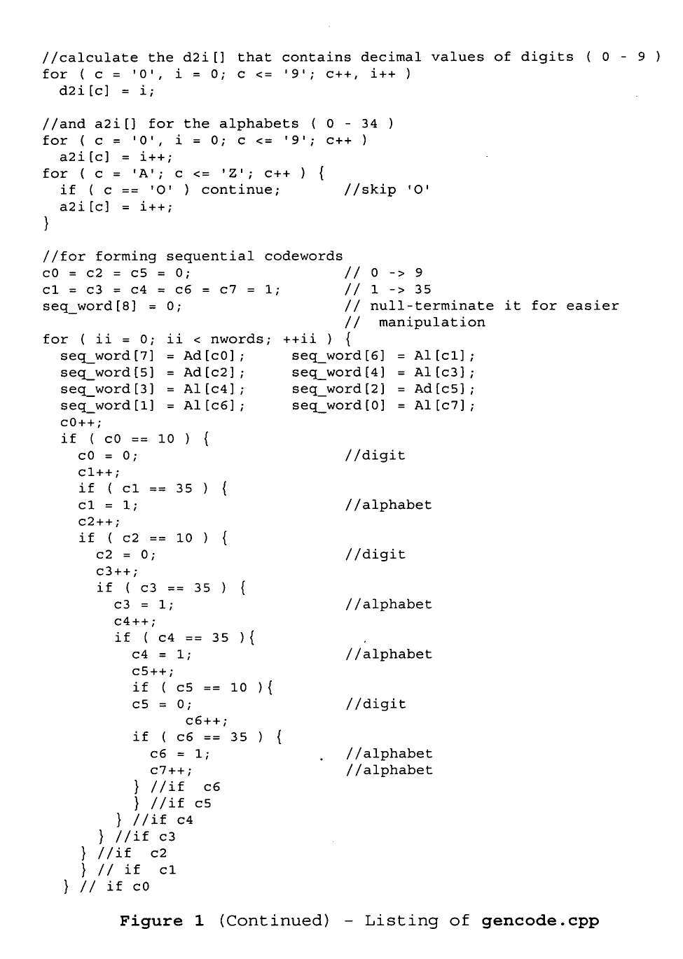

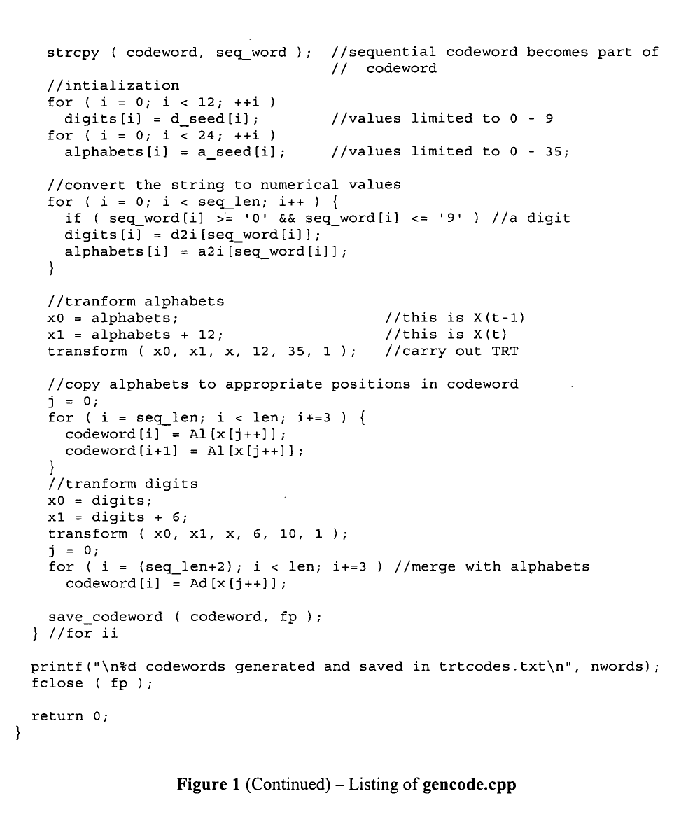

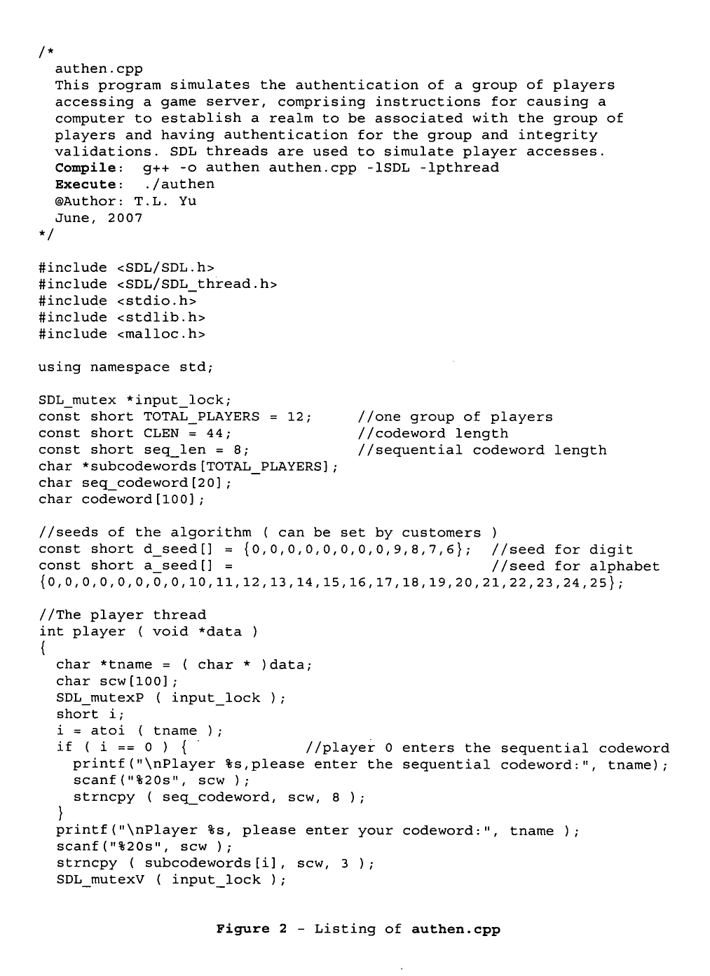

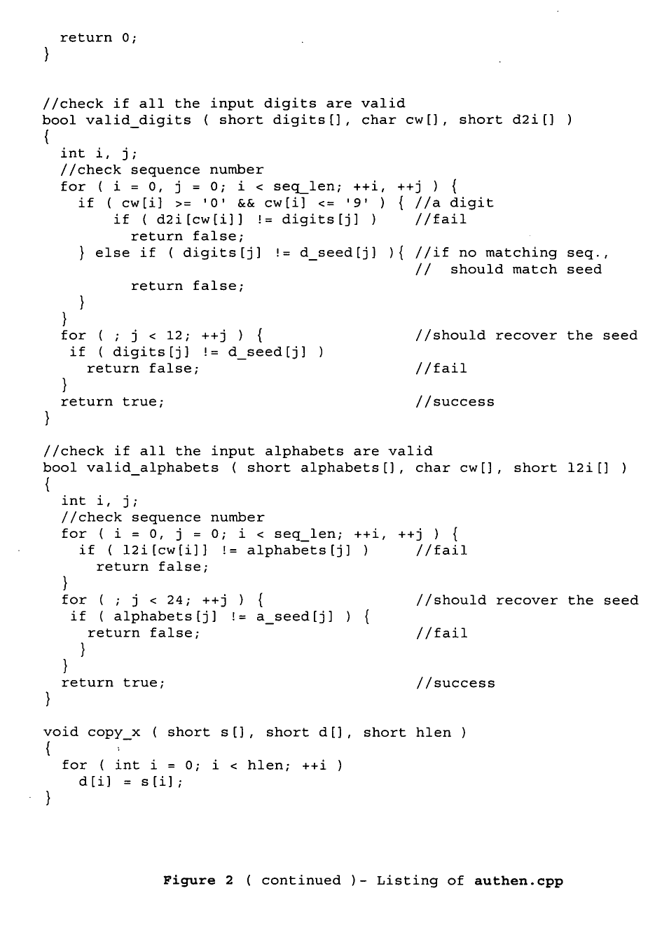

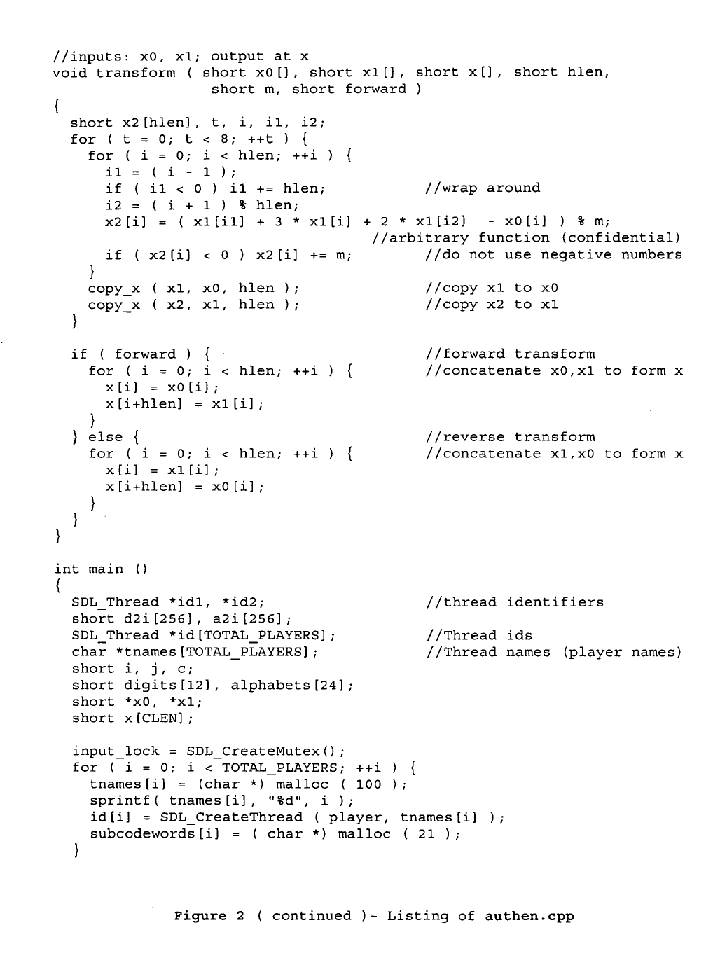

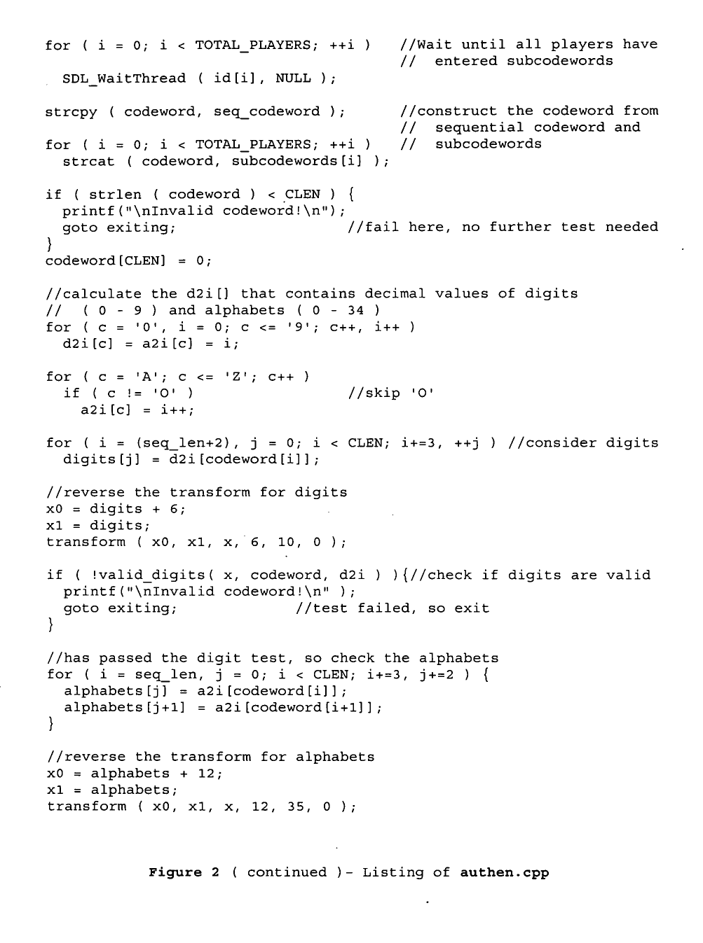

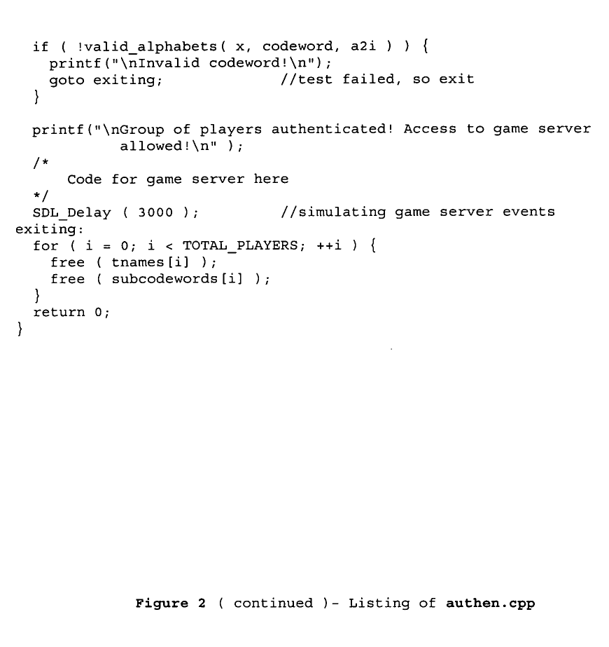

See FIG. 1 and FIG. 2.

### BACKGROUND OF THE INVENTION

This invention relates to authentication of a group of users, specifically to kids playing hand-held video games via the Internet. As computing and communication technologies advance, many hand-held video games have been integrated with the Internet. A group of friends each with a hand-held game unit can play and/or compete with other groups via the Internet. For example, a group of twelve kids can compete with other groups to win an award. The manufacturer of the game units would require each group to purchase twelve game units and require a group to provide a unique codeword to identity itself in order to login a gaming web site to compete with others; the codeword could be formed by 12 sub-codewords, each of which is associated with a game unit. The gaming web-site checks if the combined codeword is correct. If it is, all members of the group are allowed to login to compete with other groups. Such a system does not require high security to protect an unauthorized kid to play the game at a high cost. However, the codewords should appear random enough to the kids so that they cannot be easily guessed. Also, the codewords should not contain any words that are inappropriate for kids to read. The codewords should be originated from some sequential codes so that the manufacturer and the gaming web site can easily keep track of the game units.

### SUMMARY

In accordance of the present invention, a process generates unique pseudo-random codewords from simple sequential codewords using the Time Reversal Transformation. A codeword is divided into equal-sized subcodewords which are distributed to a group of game players. The process ensures that no foul-language word appears in any codeword or subcodeword. Each of the game players in a group uses the acquired subcodeword to gain access to a game server. The group leader is also responsible for entering the sequential codeword associated with the group. Access is granted to the group only if the subcodewords entered by all the players in the group are valid and are indeed generated from the sequential codeword. The verification of all the subcodewords supplied by the players is done by reversing the operation of the Time Reversal Transformation on the string formed by the subcodewords to check if the corresponding sequential codeword and seeded values can be recovered.

### DETAILED DESCRIPTION—FIG. 1 AND FIG. 2—PREFERRED EMBODIMENT

A preferred embodiment of the process of the present invention is illustrated in FIG. 1 and FIG. 2, which list the programs of the invented process written in standard C/C++ computer language.

Suppose we have a sequence X of n integer values x₀, x₁, . . . , Xₙ₋₁. We can iterate X as if we were moving forward in time t to obtain new sequences. That is,

X(t+1)=f(X(t))−X(t−1)mod m (1)

where f is an arbitrary function of xᵢ's and m is an integer; (t+1) refers to the next time-step; (t) refers to the current time-step and (t−1) refers to the previous time-step. We refer to such an operation as Time Reversal Transformation (TRT); when we reverse the time in (1), we can recover the original sequence by,

X(t−1)=f(X(t))−X(t+1)mod m (2)

Because of this time reversal properties, the sequences generated by a fixed number of iterations are always unique for unique initial sequences. For instance, consider a simple example, where n=3, m=4 and

f(X)=xᵢ₋₁+3*xᵢ+xᵢ₊₁

The operation on index i is taken mod n (e.g. when n=3 and k=−1, k mod n is 2). The values of xᵢ(t+1) is obtained by

xᵢ(t+1)=xᵢ₋₁(t)+3*xᵢ(t)−xᵢ(t−1)mod m (3)

One can interpret (3) as an automaton evolving in space and time, with i indexing the spatial components and t indexing the time components. Suppose the initial sequences are

X(0)={0,1,2}

X(1)={1,0,0}

With n=3 and m=4, we can calculate X(2) from X(1) and X(0) (i.e. t=1) using (3):

x₀(2)=x₂(1)+3*x₀(1)+x₁(1)−x₀(0)mod 4=0+3+0−0 mod 4=3

x₁(2)=x₀(1)+3*x₁(1)+x₂(1)−x₁(0)mod 4=1+0+0−1 mod 4=0

x₂(2)=x₁(1)+3*x₂(1)+x₀(1)−x₂(0)mod 4=0+0+1−2 mod 4=3

Thus X(2)={3, 0, 3 }. We can calculate X(3) from X(2) and X(1):

x₀(3)=x₂(2)+3*x₀(2)+x₁(2)−x₀(1)mod 4=3+9+0−1 mod 4=3

x₁(3)=x₀(2)+3*x₁(2)+x₂(2)−x₁(1)mod 4=3+0+3−0 mod 4=2

x₂(3)=x₁(2)+3*x₂(2)+x₀(2)−x₂(1)mod 3=0+9+3−0 mod 4=0

Thus X(3)=(3, 2, 0}. We can then calculate X(4) from X(3) and X(2), X(5) from X(4) and X(3), and so on. On the other hand, X(3) can be recovered from X(4) and X(5); X(2) can be recovered from X(3) and X(4) and so on.

We use TRT to generate pseudo-random codewords from a sequential code. Because the game units are expected to be sold in tens of millions, the sequential code space should be large. We consider a sequential code consisting of letters and digits.

In our application, as codewords are generated from alphanumeric sequences consisting of letters and digits, we need to first convert alphanumeric sequences to sequences of integers so that TRT can be applied to operate on them. To avoid any confusion that may arise in describing letters, digits, alphabets, characters, codewords, and some other related terms, we adopt the Backus-Naur Form (BNF) to describe these quantities. BNF schemes are commonly used to describe the syntax of a computer language. In this notation, a category is defined by production, also called rewriting rules, such as
digit ::=0|1|2|3|4|5|6|7|8|9
   This should be read as
The category digit is written as either
the symbol 0, the symbol 1, . . . , or the symbol 9.

The vertical bar separates alternative choices. Symbols not in italics are terminal symbols to which no further productions are applied. The symbol ::=means “to be rewritten as”. We define our terms as follows.
nonzero-digit ::=1|2|3|4|5|6|7|8|9
digit ::=0|nonzero-digit
letter ::=A|B|C|D|E|F|G|H|I|J|K|L|M|N|P|Q|R|S|T|U|V|W|X|Y|Z
alphabet ::=letter|digit
nonzero-alphabet ::=letter|nonzero-digit
sub-codeword ::=alphabet alphabet digit
nnD ::=nonzero-alphabet nonzero-alphabet digit
sequential-codeword ::=nnD nnD nonzero-alphabet digit
codeword ::=sequential-codeword {sub-codeword}₀+|{sub-codeword}₀₊

The symbol { }₀₊ means “repeat the enclosed item 0 or more times”. Note that our category letter only contains upper case letters. Also, the English letter ‘O’ is not in letter; this is to avoid any confusion with digit zero (0). Using this notation, the following are legitimate sub-codewords
AB2 2E3 XC6 FR6
   However, the following are not.
ABC DEF C1F

Codewords are composed of sub-codewords or a sequential codeword followed by sub-codewords. By enforcing the rule that any digit must appear between every two alphabets, we can be sure that foul-language words won't appear in a codeword.

Since a sequential codeword consists of five nonzero-alphabets and three digits, the size of such a code is

34⁵×10³=45,435,424,000˜45 billion

Practically, the code space is big enough to cover any number of toys distributed by any company.

To illustrate our process, we consider codewords with length 44, consisting of 44 letters or digits; more precisely, such a codeword consists of a sequential-codeword of length 8 and 12 sub-codewords; the length of each subcodeword is 3. Correspondingly, the length of the sequence X(t) is 22; that is, we break a codeword into two equal halves with the left half represented by X(t−1),and right half by X(t). X(0) is regarded as our seed and its values are preset initially. Because we have divided a codeword into sub-codewords in the format
alphabet alphabet digit
   it is more convenient to program if we separate a codeword into two sequences, one consisting of alphabets and the other consisting of digits only. We apply TRT to each sub-sequence and merge the two sub-sequences after Time Reversal Transformation has been applied to each of them. In the TRT operation, we assign the value 0 to digit 0, value 1 to digit 1 and so on. Similarly, we assign the value 10 to letter A, value 11 to letter B and so on. Let us consider an example where a length-44 codeword formed from a length-8 sequential-codeword to elaborate the concepts. In the example, the length of the sub-sequence of digits is 12 and that of the sub-sequence of alphabets is 24; we choose the sequential codeword to be
AA1AA1A1

Our initial (seeded) alphabet subsequence is
AA1AA1A1ABCDEFGHIJKLMNPQ

As one can see, the pattern “AA1AA1A1” occurred in the sequence and other values (“ABCDEFGHIJKLMNPQ”) are seeded values. On the other hand, our digit subsequence is
001001019876

The pattern “00100101” is obtained by replacing letter ‘A’ in the sequential codeword by digit ‘0’; other values (“9876”) are seeded values.

To apply TRT to the letter subsequence, we divide it into two equal halves, so that

X(0)=“AA1AA1A1ABCD”

X(1)=“EFGHIJKLMNPQ”

We choose f(X) to be

f(X)=xᵢ₋₁+3*xᵢ+2*xᵢ₊₁

and the number of iterations to be 8. Under such a TRT, we obtain X(8), and X(9):

X(8)=“J4V5F6F2P3TZ”

X(9)=“G5H7CVHH95ES”

We concatenate X(8) and X(9) to form the transformed alphabet sequence:

XA′=“J4V5F6F2P3TZG5H7CVHH95ES”

Similarly, for the case of the digit subsequence,

X(0)=“001001”

X(1)=“001001”

and

X(8)=“517254”

X(9)=“936375”

The transformed digit sequence XD′ is also obtained by concatenating X(8) and X(9):

XD′=“517254936375”

The final codeword is obtained by merging XA′ and XD′, and concatenating with the original sequential-codeword, which is shown below, where space has been artificially added for the purpose of showing the subcodewords:

codeword=“AA1AA1A1 J45 V51 F67 F22 P35 TZ4 G59 H73 CV6 HH3 957 ES5”

One can see that there are totally 12 subcodewords, each of which is in the format “alphabet alphabet digit”:
“J45” “V51” “F67” “F22” “P35” “TZ4” “G59” “H73” “CV6” “HH3” “957” “ES5”

These twelve subcodewords together is associated with a group as they are generated from a sequential codeword. Also, each of these subcodewords is associated with a game unit, the owner of which will use it to log into a game server via the Internet. In general, the group leader should provide the sequential codeword to the game server. When the game server detects that all 12 units have entered, the group associated with the sequential codeword “AA1AA1A1” is validated, which will then compete with other groups of players.

### Program Listing

FIG. 1 shows the listing of the program gencode.cpp, which generates a specified number of unique group codewords of length 44 that do not contain foul-language words from unique sequential codewords of length 8 using Time Reversal Transformation. It is written in standard C/C++ programming language and can be compiled and run in a contemporary Linux computer. To compile the program, one can issue the command
g++-o gencode gencode.cpp
   which produces the executable file gencode. To execute the program, one can use the command
./gencode

The running program will ask the user to enter the number of codewords that he or she wants to generate. Upon receiving the input, the program generates the specified number of codewords and saves them in the text file “trtcodes.txt”.

FIG. 2 shows the listing of the program authen.cpp, which simulates the authentication of a group of players accessing a game server, comprising instructions for causing a computer to establish a realm to be associated with the group of players and having authentication for the group and integrity validations. SDL threads are used to simulate player accesses. It is written in standard C/C++ programming language. It can be compiled and run in a contemporary Linux computer. To compile the program, issue the command
g++-o authen authen.cpp -1SDL -1pthread
   which generates the executable authen. To run the program, simply execute
./authen

The program simulates the 12 players using SDL threads. Player 0 is responsible for entering the sequential codeword of the group. Each of all twelve players needs to enter his or her own subcodeword. The group is allowed to access a game server only if all the twelve subcodewords entered are correct.

We claim:

1. A process for generating unique pseudo-random codewords, free of foul-language words, from simple sequential codewords for a group of players to access a game server requiring validation and integrity check, comprising:
a. forming a sequential codeword using letters separated by digits to avoid foul-language words,
b. mapping said letters and said digits to integers,
c. forming a sequence of integer values X(t) at time step t=1, with a fixed length by concatenating said sequential codeword with arbitrary seeded integer values,
d. forming a background sequence of integers X(t−1), with arbitrary seeded integer values of said length,
e. operating on said sequence of integer values X(t) using an arbitrary function, f consisting of arithmetic operations addition, subtraction, multiplication and division to obtain f[X(t)],
f. subtracting the resulted sequence f[X(t)] in step e) from said background sequence X(t−1), taking modulus with respect to an integer m to form a new sequence of integers X(t+1),
g. setting t+1 to t so that said sequence X(t) becomes background sequence X(t−1) and said new sequence X(t+1) becomes X(t),
h. repeating steps e) to g) for a fixed number of times, N to ensure said sequence X(t) appear random enough for practical use,
i. subdividing said sequence X(t) into subcodewords, each of which is associated with said group player.

2. A process for allowing a computer to establish a realm to be associated with a group of players and having authentication for the associated group and integrity validations for accessing a game-server, comprising:
a. said game server receiving said sequential codeword of claim 1 and subcodewords generated according to claim 1 from said group players,
b. concatenating said sequential codeword and all said subcodewords to form one sequence,
c. dividing said sequence into two equal halves to form sequence X(t+1) and sequence X(t),
d. operating on said sequence X(t) using said function f of claim 1 to obtain f[X(t)],
e. obtaining sequence X(t−1) by subtracting said sequence X(t+1) from f[X(t)], taking modulus with respect to said integer m of claim 1, setting t to t−1 so that said sequence X(t+1) in step d) becomes X(t) and said sequence X(t) in step d) becomes X(t−1),
f. repeating steps d) to f) for said number of times N of claim 1 to recover sequences X(1) and X(0),
g. checking said sequences X(1) and X(0) against said sequential codeword and said seeded values of claim 1 to validate said group of players.
